(19) United States
(12) Patent Application Publication
(10) Pub. No.: US 2026/0051775 A1
(43) Pub. Date: Feb. 19, 2026

(54) MECHANICAL PIN RETENTION CONFIGURATION AND RELATED METHOD FOR RETAINING MAGNETS IN ELECTRIC MACHINES

(71) Applicant: FCA US LLC, Auburn Hills, MI (US)

(72) Inventors: Reza Ghafoori-Ahangar, Auburn Hills, MI (US); Dhafar Al-Ani, Auburn Hills, MI (US)

(21) Appl. No.: 18/801,920

(22) Filed: Aug. 13, 2024

(51) Int. Cl. H02K 1/30; B60L 50/51; H02K 15/03; H02K 15/12

(52) U.S. Cl. CPC H02K 1/30; H02K 15/03; H02K 15/12; B60L 50/51

(57) ABSTRACT

An electric motor for powering an electric vehicle includes a rotor including a plurality of first rotor laminations and a second rotor lamination. The rotor has a slot edge that defines a rotor slot configured to receive a first magnet therein. The plurality of first rotor laminations are stacked upon each other, each having a first pattern. The second rotor lamination is located between adjacent first rotor laminations of the plurality of first rotor laminations, the second rotor lamination having a second pattern distinct from the first pattern, the second pattern including a first pin shaped retention mechanism defined thereon. The first pin shaped retention mechanism is configured to deflect as a result of engagement with the magnet during insertion of the magnet into the rotor slot creating a first retention load in a first direction onto the magnet retaining the magnet within the rotor slot.

### FIELD

The present application relates generally to electric drive modules for electric vehicles and, more particularly, to a mechanical pin retention configuration and related method for retaining magnets in electric machines.

### BACKGROUND

Different types of electric vehicles, including mild hybrid electric vehicles (mHEV's), plug-in hybrid electric vehicles (PHEV's), battery electric vehicles (BEV's), and extended-range battery electric vehicles (EREV's), rely on electric machines for propulsion as a main source of torque, which generates the necessary power for vehicle propulsion. Electrical machines that include permanent magnets in the rotor' electric steel lamination stacks is called an interior permanent magnet (IPM). In some instances, particularly at higher speed electric machines, it can be challenging to retain the permanent magnets in the rotor lamination stacks. Prior art methods of retaining magnets in the rotor laminations include mold injection, adhesives, mold transfer, wavy springs, punching and other retention strategies that each present various drawbacks. In this regard, while existing retention configurations can be satisfactory, there remains a need for improvement in the relevant art.

### SUMMARY

In accordance with one example aspect of the invention, an electric motor for powering an electric vehicle includes a rotor including a plurality of first rotor laminations and a second rotor lamination. The rotor is configured to rotate relative to a stator to drive a rotor shaft and at least one drive wheel of the electric vehicle, the rotor having a slot edge that defines a rotor slot configured to receive a first magnet therein. The plurality of first rotor laminations are stacked upon each other, each having a first pattern. The second rotor lamination is located between adjacent first rotor laminations of the plurality of first rotor laminations, the second rotor lamination having a second pattern distinct from the first pattern, the second pattern including a first pin shaped retention mechanism defined thereon, the first and second rotor laminations collectively defining a stopper, the first pin shaped retention mechanism disposed at the stopper and extending into the rotor slot. The first pin shaped retention mechanism is configured to deflect as a result of engagement with the magnet during insertion of the magnet into the rotor slot creating a first retention load in a first direction onto the magnet retaining the magnet within the rotor slot.

In examples, the second lamination further comprises a second pin shaped retention mechanism disposed at the slot edge and that extends generally into the rotor slot.

In other arrangements, the second pin shaped retention mechanism is configured to deflect as a result of engagement with the magnet during insertion of the magnet into the rotor slot creating a second retention load onto the magnet in a second direction retaining the magnet within the rotor slot.

In examples, the first and second directions are distinct.

In other arrangements, the second rotor lamination defines a groove, wherein the second pin shaped retention mechanism is configured to deflect at least partially into the groove as a result of the engagement with the magnet.

In implementations, the first and second pin shaped retention mechanisms provide a spring-back force onto the magnet.

In accordance with one example aspect of the invention, a method is provided for assembling a rotor configured for use in an electric machine for powering an electric vehicle, the rotor configured to rotate relative to a stator to drive a rotor shaft and at least one drive wheel of the electric vehicle, the rotor defining at least a first rotor slot configured to receive a magnet therein. The method includes: arranging a plurality of first rotor laminations stacked upon each other, each having a first pattern; arranging a second rotor lamination between adjacent first rotor laminations of the plurality of first rotor laminations, the second rotor lamination having a second pattern distinct from the first pattern, the second pattern including a first pin shaped retention mechanism defined thereon, the first and second rotor laminations collectively defining a stopper, the first pin shaped retention mechanism disposed at the stopper and extending into the rotor slot; inserting a magnet into the rotor slot; and wherein insertion of the magnet causes the first pin shaped retention mechanism to deflect as a result of engagement with the magnet during insertion of the magnet into the rotor slot creating a first retention load in a first direction onto the magnet retaining the magnet within the rotor slot.

In other features of the method, the second lamination further comprises a second pin shaped retention mechanism disposed at the slot edge and that extends generally into the rotor slot; and wherein insertion of the magnet causes the second pin shaped retention mechanism to deflect as a result of engagement with the magnet during insertion of the magnet into the rotor slot creating a second retention load onto the magnet in a second direction retaining the magnet within the rotor slot.

In additional examples of the method, the first and second directions are distinct.

In other examples of the method, the second rotor lamination defines a groove, wherein the second pin shaped retention mechanism deflect at least partially into the groove as a result of the engagement with the magnet.

In additional features of the method, the first and second pin shaped retention mechanisms provide a spring-back force onto the magnet.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates a mechanical arrangement for retaining magnets in a rotor lamination stack, in accordance with the principles of the present application;

FIG. 2 is a rotor laminations stack and magnet assembly used in an electric machine of the electric drive module shown in FIG. 1, in accordance with the principles of the present application;

FIG. 3 is a detail view of a rotor lamination showing a gap between the magnet and rotor slot, in accordance with the principles of the present application;

FIG. 4A is a schematic illustration of a pin shaped retention mechanism shown in an undeformed position according to principles of the present application;

FIG. 4B is a schematic illustration of the pin shaped retention mechanism of FIG. 4A shown with a magnet initially engaging the pin shaped retention mechanism;

FIG. 4C is a schematic illustration of the pin shaped retention mechanism of FIG. 4B shown with the magnet further engaging the pin shaped retention mechanism as it is advanced into a rotor lamination slot, the pin shaped retention mechanism deforming as a result of engagement with the magnet and applying a spring-back force onto the magnet thereby retaining the magnet in the rotor lamination slot;

FIG. 5A is an exemplary rotor lamination slot without undercut geometries;

FIG. 5B is an exemplary rotor lamination slot having undercuts defined at the rotor lamination slot edge, the undercuts providing a relief whereby the respective pin shaped retention mechanism can deform thereat;

FIG. 6 is a plan view of a lamination pattern in the rotor, the lamination pattern including a series of pin shaped retention mechanisms, the pin shaped retention mechanisms configured to deform in a transverse direction of magnet insertion;

FIG. 7A is a partial perspective view of a section of a rotor lamination stack having a plurality of first lamination layers having a first pattern and a predetermined amount of second lamination layers having a second pattern that includes pin shaped retention mechanisms thereon according to additional features of the instant application;

FIG. 7B is a partial perspective view of the section of rotor lamination stack illustrated in FIG. 7A and shown with the pin shaped retention mechanisms of the second lamination layers applying a spring-back force onto a magnet subsequent to magnet insertion;

FIG. 8A is a partial perspective view of a section of a rotor lamination stack having a plurality of first lamination layers having a first pattern and a predetermined amount of second lamination layers having a second pattern that includes pin shaped retention mechanisms thereon, the first and second lamination layers collectively defining an undercut or groove thereon according to additional features of the instant application;

FIG. 8B is a detail view of the groove defined on the first and second lamination layers of the section of rotor lamination stack of FIG. 8A;

FIG. 8C is a side view of a first lamination layer and a second lamination layer, the pin shaped retention mechanism of the second layer applying a spring-back force onto a magnet subsequent to magnet insertion; and

FIG. 8D is a side view of a pin shaped retention mechanism having an adjacent groove and constructed in accordance to additional features of the present disclosure.

### DETAILED DESCRIPTION

As noted above, electric machines are used in various types of electrified vehicles to generate the necessary power for vehicle propulsion. Electrical machines include rotor lamination stacks that incorporate magnets disposed within slots defined in the rotor lamination stacks. In some circumstances, it can be challenging to retain the magnets in the rotor lamination stacks. For example, during assembly on a production line it is important to adequately retain the magnets in the rotor lamination stacks. Furthermore, during operation of the rotor in an electric machine, adequate retention is essential for accounting for the centrifugal force seen during rotation. Prior solutions for retaining magnets in the rotor lamination slots included adhesive, mold injection, mold transfer, retaining sleeves, wavy springs, tab and groove and punching.

In some existing arrangements, the magnets in the rotor laminations stack are retained in place by biasing members such as wavy springs that are inserted between the magnets and the rotor slot edges. These wavy springs are formed of a metal having shape memory and can be inserted as ductile flat sheets at low temperature, becoming stiff wavy springs at normal ambient temperatures. The flexibility of the wavy spring allows it to absorb minor shocks and vibrations, protecting the magnet from damage due to sudden impacts or movements. Wavy springs can have a limited load-bearing capacity compared to the present disclosure, which could be a concern in applications requiring high retention force. Over time, repeated compression and expansion of the wavy spring can lead to wear and fatigue, potentially reducing the effectiveness of the wavy spring. Furthermore, the design of the wavy spring requires additional space around the magnet, which could be a limitation in compact or tight-fitting applications. Moreover, wavy springs are sensitive to changes in temperature or humidity, which could affect their performance and reliability in certain environments.

In other prior arrangements, tab and grooves are incorporated into selected rotor laminations which undergo deformation upon magnet insertion. Tab and grooves provide secure retention on the magnet and minimize the risk of movement of the magnet. Tab and grooves have a lower load-bearing capacity compared to the instant disclosure, which could be a concern in applications requiring high speed. There are multiple lamination layouts for incorporating tab and grooves making the assembly process complex.

In another prior art configuration, a rotor slot's edge undergoes plastic deformation, effectively retaining the magnet through this deformation. The punching method can cause damage to the magnet or surrounding components if not executed with precision or if excessive force is applied. Although there is generally good process control during punching, there is potential for pre-stress and load on the magnets. Depending on the material and thickness of the stack, punched retention features are limited to the surface of the stack and does not consider retention of the magnets within the stack depth. Moreover, aligning and positioning the punch tool accurately during assembly requires additional time and effort, especially for complex designs or tight tolerances.

According to the principles of the present application, a mechanical pin shaped retention configuration and related method for retaining magnets in electric machines is provided. The pin shaped retention configuration includes a pin shaped member that extends from the rotor and is deflected as a result of insertion of the magnet into the respective rotor slot. The insertion of the magnet causes the pin to deflect into an undercut defined in the rotor at the rotor slot. The pin shaped member, due to the deforming, exerts a spring-back force between the magnet and the rotor slot edge securing the magnet in place. In examples, a first pin shaped member is arranged along the rotor slot and a second pin shaped member is arranged along a stopper extending toward the rotor slot. This combination enables the creation of retention loads in two directions within the gap between the magnet and the edge of the rotor slot. The configurations and methods described herein is applicable to all types of electric machines (electric motor and generator) with magnets.

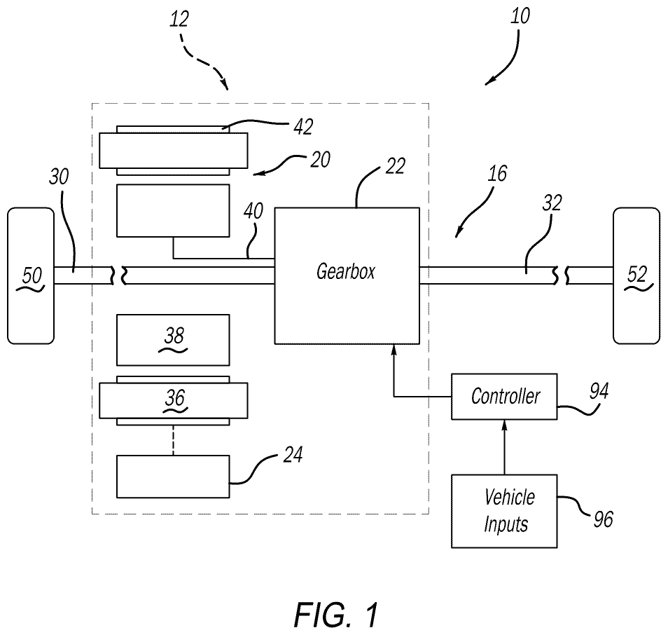

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), an electric drive gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 and a second or right axle shaft 32. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle.

In the example embodiment, the electric machine 20 generally includes a stator 36, a rotor 38, and a rotor output shaft 40. The stator 36 is fixed (e.g., to a housing 42) and the rotor 38 is configured to rotate relative to the stator 36 to drive the rotor shaft 40 and thus the vehicle axles 30, 32 (e.g., half shafts) and therefore respective drive wheels 50, 52. In the illustrated example, the EDM 12 is configured for a rear axle (axles 30, 32) of the vehicle 10, but it will be appreciated that the systems and methods described herein are equally applicable to a front axle EDM configuration, and can be replicated on the front and rear axles for four wheel drive.

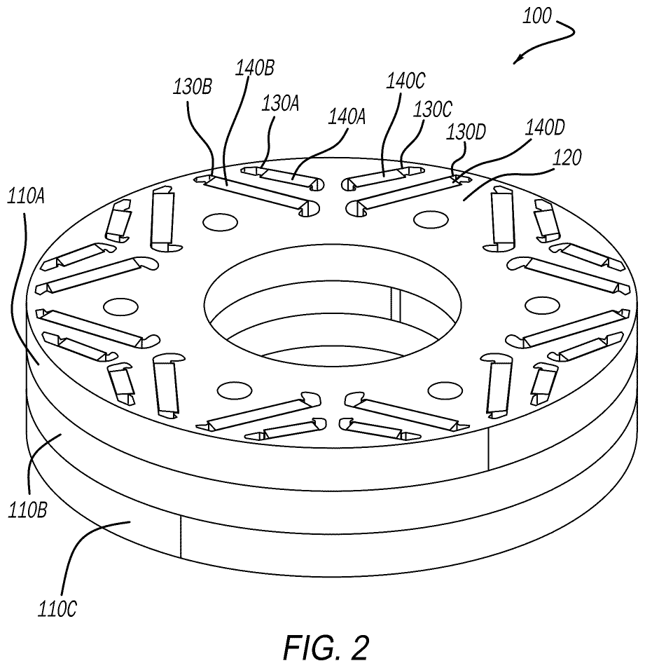

With reference now to FIG. 2, a rotor laminations stack and magnet assembly used in an electric machine of the electric drive module shown in FIG. 1 is shown and generally identified at reference numeral 100. The exemplary rotor laminations stack and magnet assembly 100 includes a first stack 110A, a second stack 110B and a third stack 110C. It is appreciated that more layers may be provided. A rotor lamination 120 generally defines various pockets or slots 130A, 130B, 130C, 130D, etc. configured to receive complementary magnets 140A, 140B, 140C, 140D, etc.

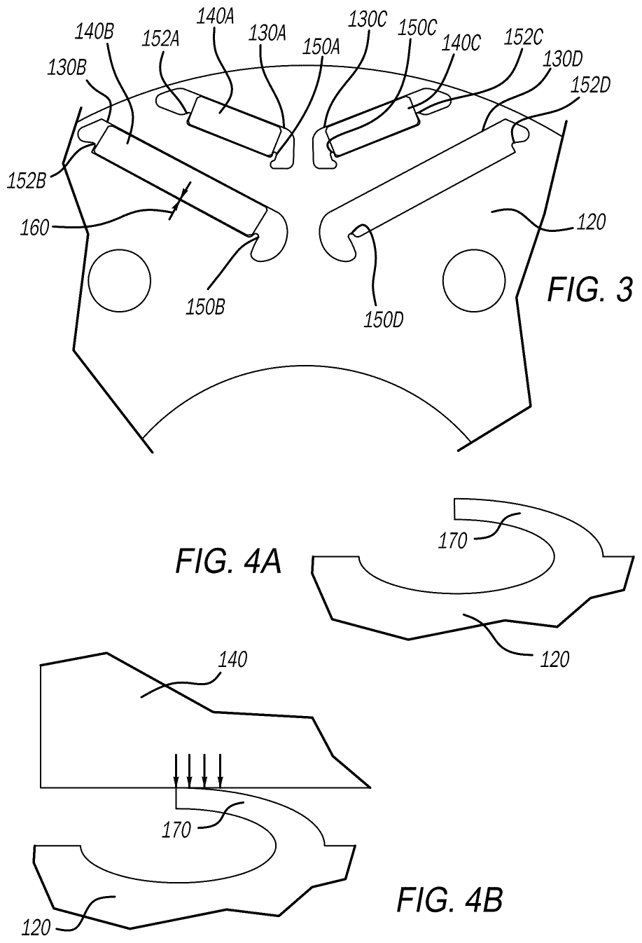

With additional reference to FIGS. 2 and 3, the rotor laminations stack and magnet assembly 100 will be further described. Various stoppers 150A-150D and 152A-152D are arranged on the rotor lamination 120 that extend generally in a direction into the respective slot(s) 130A, 130B, 130C, 130D, etc. In general, a gap 160 is defined between the respective magnets 140 and rotor lamination 120.

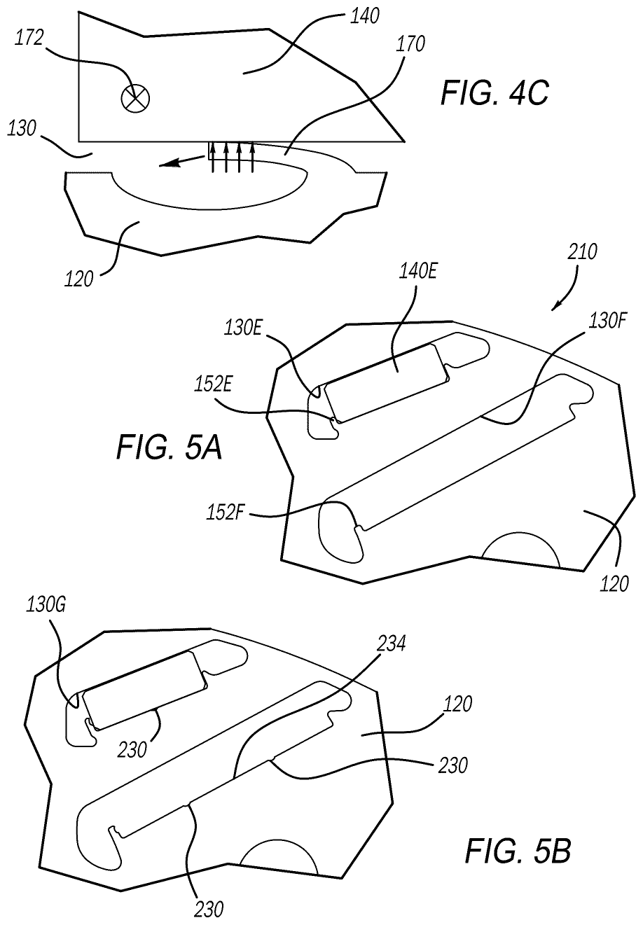

With reference now to FIGS. 4A-4C, principles of the present disclosure will be described with respect to a pin shaped retention mechanism 170. FIG. 4A is a schematic illustration of the pin shaped retention mechanism 170 extending from a rotor lamination 120 and shown in an undeformed position according to principles of the present application. FIG. 4B is a schematic illustration of the pin shaped retention mechanism 170 of FIG. 4A shown with a magnet 140 initially engaging the pin shaped retention mechanism 170. FIG. 4C is a schematic illustration of the pin shaped retention mechanism 170 of FIG. 4B shown with the magnet 140 further engaging the pin shaped retention mechanism 170 as the magnet 140 is advanced into a rotor lamination slot in a direction 172 (generally into the page). The pin shaped retention mechanism 170 deforms as a result of engagement with the magnet 140 and applying a spring-back force onto the magnet 140 thereby retaining the magnet in the rotor lamination slot 130.

Turning now to FIGS. 5A and 5B, additional features of the instant disclosure will be described. FIG. 5A is an exemplary first rotor lamination slot pattern 210 without undercut geometries. The first lamination pattern 210 presents a geometry similar to described above with respect to FIG. 3 whereby the magnet 140E is inserted into the respective slot 130E. In particular, the lamination pattern 210 includes stoppers 152E and 152F that generally extend into the respective slots 130E and 130F that engage respective magnets (such as magnet 140E illustrated in FIG. 5A). The stoppers 152E and 152F extend into the slots in such a manner that they are not deflected during insertion of the magnets. As will become appreciated from the following discussion, the lamination layer shown in FIG. 5A is a first lamination that does not include a pin shaped retention mechanism.

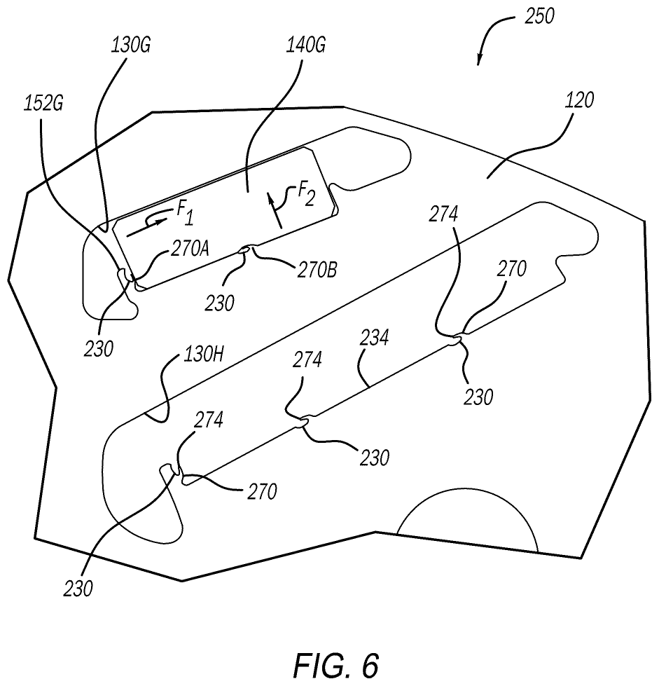

FIG. 5B is an exemplary rotor lamination slot 130G having undercuts 230 defined at the rotor lamination slot edge 234, the undercuts 230 providing a relief whereby the respective pin shaped retention mechanism (described below with respect to FIG. 6) can deform thereat.

With further reference now to FIG. 6, additional features of the instant disclosure will be described. FIG. 6 is a plan view of a lamination pattern 250 in the rotor 120, the lamination pattern 250 includes a series of pin shaped retention mechanisms 270. The pin shaped retention mechanisms 270 generally include a hook shaped end 274 that is configured to deform in a transverse direction of insertion of the magnet 140G (see also explanation at FIG. 4C). In examples, as described above, undercuts 230 provide relief whereby the respective pin shaped retention mechanism 270 can be at least partially received.

The lamination pattern 250 incorporates the pin shaped retention mechanisms 270 to fill the gap between the magnet 140 and the rotor lamination slot edge 234 after insertion of the magnet (see magnet 140G in FIG. 6 shown subsequent to insertion into the rotor slot 130G). The pin shaped retention mechanisms 270 are capable of deforming in the case of maximum material condition (MMC). In the case of least material condition (LMC), the pin shaped retention mechanisms 270 aid in the precise positioning of the magnet 140 within the rotor lamination slot 130.

In examples, the geometry and quantity of the pin shaped retention mechanisms 270 can be tailored based on criteria such as the required load and the need for multi-point contact to retain the magnet. The pin shaped retention mechanisms 270 can be strategically added to specific laminations throughout the depth of the rotor lamination stack. In this regard, each individual magnet can be retained separately in situations involving a segmented magnet. In other examples, the lamination stack can assemble with just the lamination pattern 250. In this regard, after the magnet insertion, all pin shaped retention mechanisms along the rotor lamination stack depth can deform to have the spring-back force and then retain the respective magnet within the lamination slots.

As noted above, the pin shaped retention mechanisms 270 are deflected in a transverse direction of magnet insertion (see FIG. 4C). Furthermore, multiple pin shaped retention mechanisms 270 can be incorporated at each slot 130. In some examples, a first pin shaped retention mechanism 270A can be arranged on a stopper 152G for providing a first retention force F₁ onto the magnet 140G in a direction generally perpendicular to a second retention force F₂ onto the magnet 140G provided by a second pin shaped retention mechanism 270B. In some arrangements, the magnet 140 can be chamfered to support initial slidable negotiating along the respective pin shaped retention mechanisms 270.

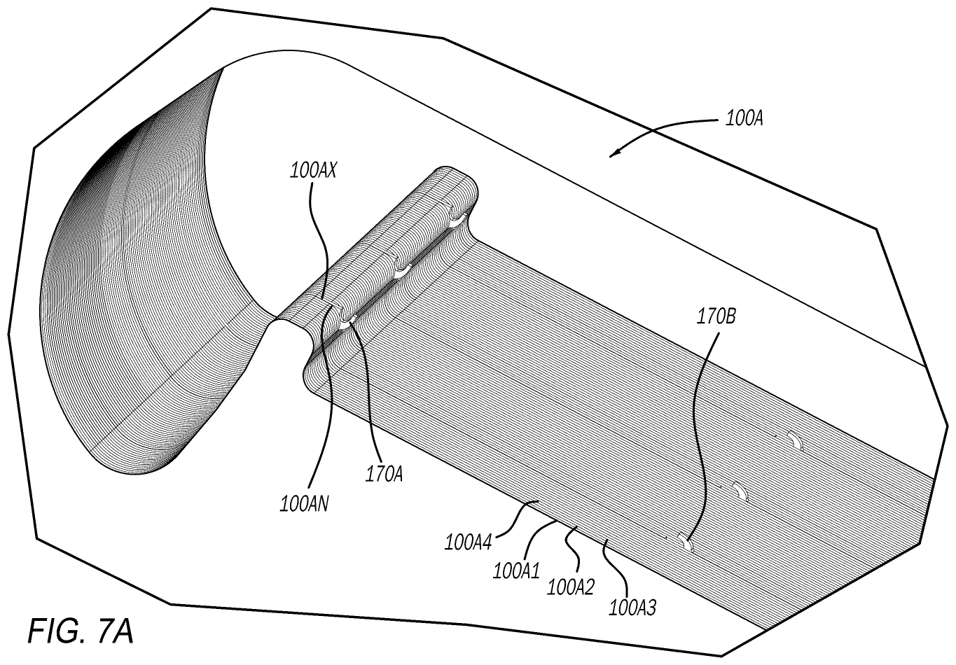

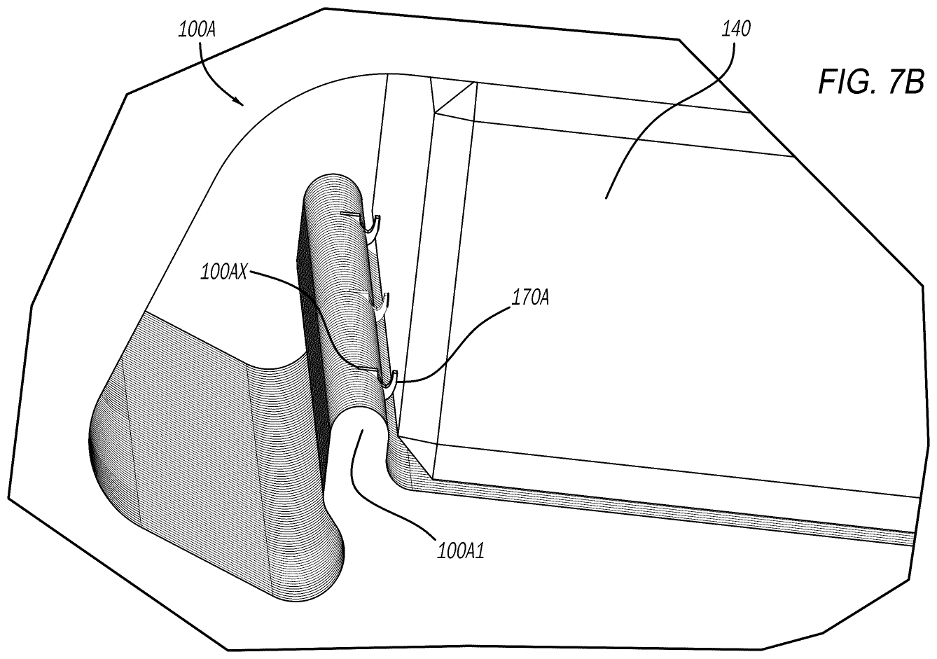

Turning now to FIGS. 7A and 7B, a partial perspective view of a section of a rotor lamination stack 100A is shown. The rotor lamination stack 100A includes a plurality of first lamination layers 100A1, 100A2, 100A3, 100A4, etc. At predetermined intervals, a second rotor lamination layer 100AX is provided. The second rotor lamination 100AX includes pin shaped retention mechanisms 170A, 170B. It is appreciated that the second rotor lamination 100AX can be located only at some of the layers. While three rotor laminations 100AX having the pin shaped retention mechanisms 170A, 170B are shown in the example in FIG. 7A, other quantities may be provided with the understanding that the second rotor laminations 100AX having the retention mechanisms 170A, 170B are significantly outnumbered by the first lamination layers 100A1, 100A2, etc. For illustrative purposes, the first lamination layer immediately adjacent to the second lamination 100AX is labelled as 100AN.

FIG. 7B shows the section of rotor lamination stack 100A illustrated in FIG. 7A with the pin shaped retention mechanisms 170A of the second lamination layers 100AX applying a spring-back force onto a magnet 140 subsequent to magnet insertion;

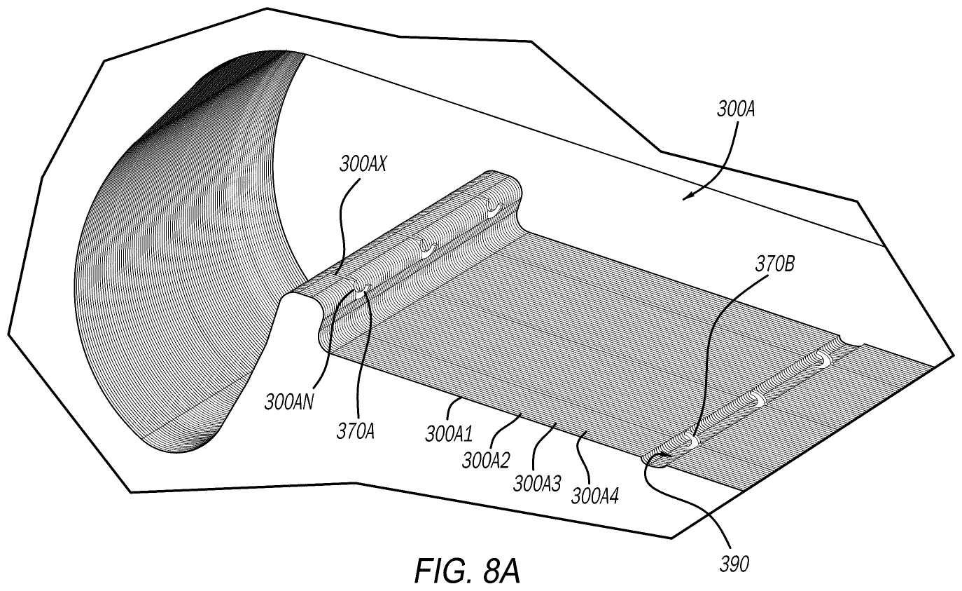

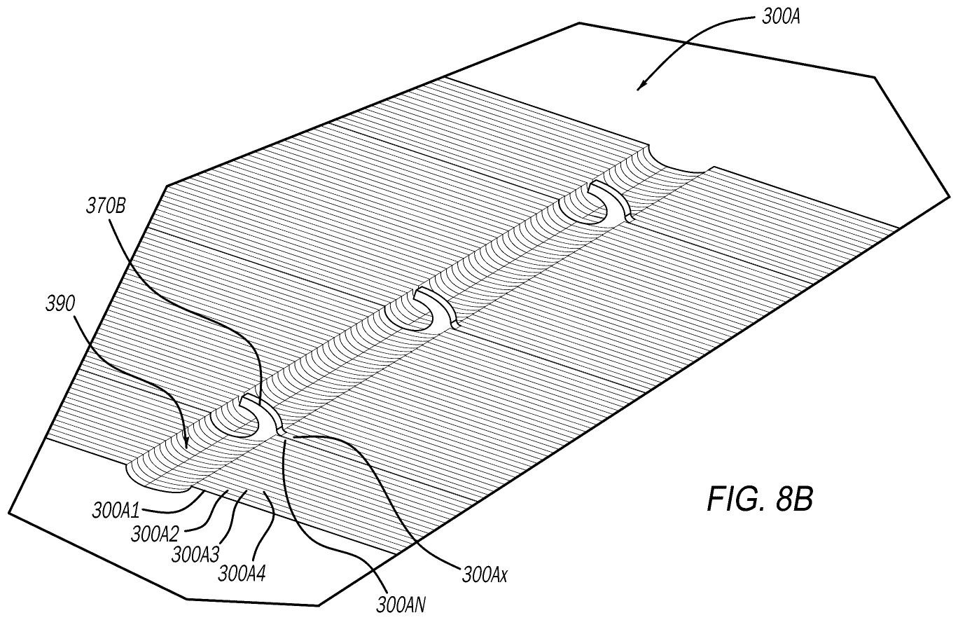

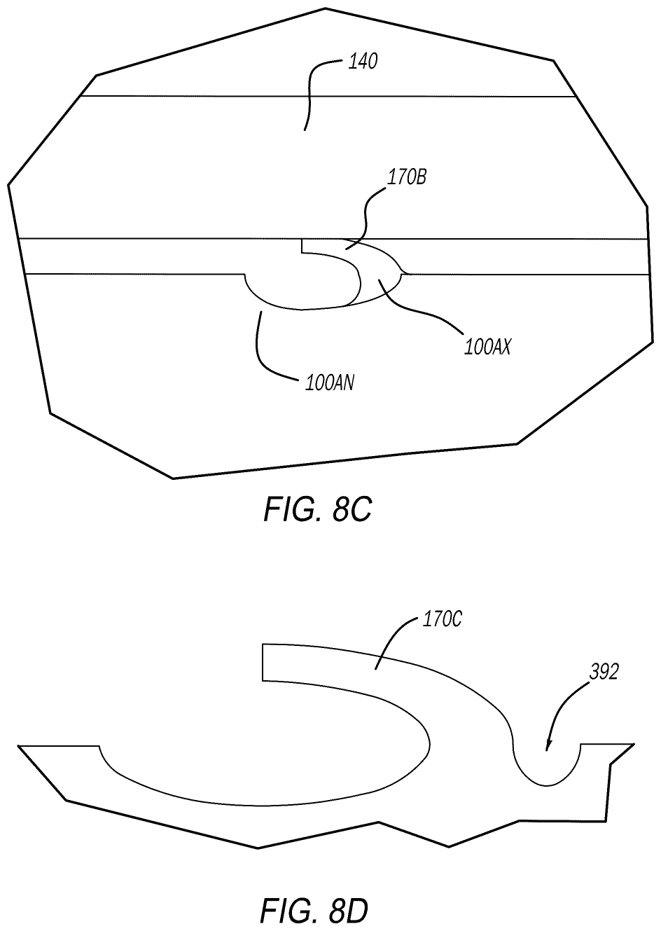

FIG. 8A is a partial perspective view of a section of a rotor lamination stack 300A is shown. The rotor lamination stack 300A is constructed similarly to the rotor lamination stack 100A described above. In this regard, like reference numerals increased by 200 are used to denote like features. The rotor lamination stack 300A includes a plurality of first lamination layers 300A1, 300A2, 300A3, 300A4, etc. At predetermined intervals, a second rotor lamination layer 300AX is provided. The second rotor lamination 300AX includes pin shaped retention mechanisms 370A, 370B. It is appreciated that the second rotor lamination 300AX can be located only at some of the layers. While three rotor laminations 300AX having the pin shaped retention mechanisms 370A, 370B are shown in the example in FIG. 8A, other quantities may be provided with the understanding that the second rotor laminations 300AX having the retention mechanisms 370A, 370B are significantly outnumbered by the first lamination layers 300A1, 300A2, etc. For illustrative purposes, the first lamination layer immediately adjacent to the second lamination 300AX is labelled as 300AN. The first and second rotor lamination layers collectively define an undercut or groove 390 thereon. The groove 390 provides a relief where the pin shaped retention mechanisms 370B can deflect subsequent to insertion of the magnet 140.

FIG. 8C is a side view of a first lamination layer 100AN and a second lamination layer 100AX, the pin shaped retention mechanism 170B of the second lamination layer 100AX applying a spring-back force onto the magnet 140 subsequent to magnet insertion.

FIG. 8D is a side view of a pin shaped retention mechanism 170C having an adjacent groove 392 and constructed in accordance to additional features of the present disclosure. The groove 392 can accommodate material deflection when the pin shaped retention mechanism 170C deflects upon magnet insertion.

With the configuration described herein, supplemental retention, such as mold injection 144 (FIG. 1) is not needed. As can be appreciated, eliminating mold injection is a substantial cost savings.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric motor for powering an electric vehicle, the electric motor comprising:
a rotor configured to rotate relative to a stator to drive a rotor shaft and at least one drive wheel of the electric vehicle, the rotor having a slot edge that defines a rotor slot configured to receive a magnet therein, the rotor comprising:
a plurality of first rotor laminations stacked upon each other, each having a first pattern;
a second rotor lamination located between adjacent first rotor laminations of the plurality of first rotor laminations, the second rotor lamination having a second pattern distinct from the first pattern, the second pattern including a first pin shaped retention mechanism defined thereon, the first and second rotor laminations collectively defining a stopper, the first pin shaped retention mechanism disposed at the stopper and extending into the rotor slot; and
wherein the first pin shaped retention mechanism is configured to deflect as a result of engagement with the magnet during insertion of the magnet into the rotor slot creating a first retention load in a first direction onto the magnet retaining the magnet within the rotor slot.

2. The electric motor of claim 1, wherein the second lamination further comprises a second pin shaped retention mechanism disposed at the slot edge and that extends generally into the rotor slot.

3. The electric motor of claim 2, wherein the second pin shaped retention mechanism is configured to deflect as a result of engagement with the magnet during insertion of the magnet into the rotor slot creating a second retention load onto the magnet in a second direction retaining the magnet within the rotor slot.

4. The electric motor of claim 3, wherein the first and second directions are distinct.

5. The electric motor of claim 3, wherein the second rotor lamination defines a groove, wherein the second pin shaped retention mechanism is configured to deflect at least partially into the groove as a result of the engagement with the magnet.

6. The electric motor of claim 1, wherein the first and second pin shaped retention mechanisms provide a spring-back force onto the magnet.

7. A method for assembling a rotor configured for use in an electric machine for powering an electric vehicle, the rotor configured to rotate relative to a stator to drive a rotor shaft and at least one drive wheel of the electric vehicle, the rotor defining at least a first rotor slot configured to receive a magnet therein, the method comprising:
arranging a plurality of first rotor laminations stacked upon each other, each having a first pattern;
arranging a second rotor lamination between adjacent first rotor laminations of the plurality of first rotor laminations, the second rotor lamination having a second pattern distinct from the first pattern, the second pattern including a first pin shaped retention mechanism defined thereon, the first and second rotor laminations collectively defining a stopper, the first pin shaped retention mechanism disposed at the stopper and extending into the rotor slot;
inserting a magnet into the rotor slot; and
wherein insertion of the magnet causes the first pin shaped retention mechanism to deflect as a result of engagement with the magnet during insertion of the magnet into the rotor slot creating a first retention load in a first direction onto the magnet retaining the magnet within the rotor slot.

8. The method of claim 7, wherein the second lamination further comprises a second pin shaped retention mechanism disposed at the slot edge and that extends generally into the rotor slot; and wherein insertion of the magnet causes the second pin shaped retention mechanism to deflect as a result of engagement with the magnet during insertion of the magnet into the rotor slot creating a second retention load onto the magnet in a second direction retaining the magnet within the rotor slot.

9. The method of claim 8, wherein the first and second directions are distinct.

10. The method of claim 9, wherein the second rotor lamination defines a groove, wherein the second pin shaped retention mechanism deflect at least partially into the groove as a result of the engagement with the magnet.

11. The method of claim 8, wherein the first and second pin shaped retention mechanisms provide a spring-back force onto the magnet.
